(19) United States
(12) Patent Application Publication
(10) Pub. No.: US 2025/0225324 A1
(43) Pub. Date: Jul. 10, 2025

(54) TOXICITY DETECTION USING NATURAL LANGUAGE PROCESSING

(71) Applicant: International Business Machines Corporation, Armonk, NY (US)

(72) Inventors: Al Chakra, Apex, NC (US); Davide Fazzone, Baiano (IT); Emre Duzenli, London (GB); David-Jude Chung, Jackson Heights, NY (US)

(21) Appl. No.: 18/403,985

(22) Filed: Jan. 4, 2024

(51) Int. Cl. G06F 40/289

(52) U.S. Cl. CPC G06F 40/289

(57) ABSTRACT

A system may include a memory and a processor in communication with the memory. The processor may be configured to perform operations. The operations may include detecting a discussion between a first user and a second user and analyzing the discussion for one or more toxicity indicators. The operations may include calculating a first user toxicity score based on the one or more toxicity indicators and implementing, automatically, a response to the first user toxicity score.

### BACKGROUND

The present disclosure relates to inappropriate content detection and, more specifically, to detection and mitigation of inappropriate behavior in a virtual environment.

Virtual environments are used by individuals to collaborate, work, and play. Individuals sharing a virtual environment may or may not know each other from outside of the virtual environment. Some virtual environments are used to interact with others who may or may not have the same or similar goals such as completing a project or achieving a milestone in a game. In some virtual environments, inappropriate behavior may exist.

For purposes of this document, a virtual environment is defined as any networked application that allows a user to interact with both a computing environment and the work of other individual human users. Email, chat, and web-based document sharing applications are all examples of virtual environments. Virtual environments are networked common operating spaces. Once the fidelity of the virtual environment is such that it creates a psychological state in which the individual perceives himself or herself as existing within the virtual environment, then the virtual environment (VE) has progressed into the realm of immersive virtual environments (IVEs, which are a form of virtual environment).

Current mechanisms for handling (e.g., mitigating and/or discouraging) inappropriate behavior include human moderators overseeing discussions and/or activities of participants in the virtual environment to ensure proper conduct, blocking of words recognized as inappropriate from showing in a chat box (e.g., a blocklist for vulgarity), and/or penalizing (e.g., squelching) users writing terms that were predefined as inappropriate. The current mechanisms for handling inappropriate behavior are not standardized even within a platform, fail to consider context, and/or may be human resource intensive.

As used herein, the term toxicity does not refer to forms of physiological damage caused by chemical agents (that is, toxins) or harmful microorganisms. Rather, for purposes of this document, toxicity may be abusive behavior in the form of rude, aggressive, degradation, profanity, or insults; toxicity may come in the form of attitude, speech (e.g., tone or word choice), actions (e.g., acts done with a virtual avatar), and/or combinations thereof.

Computing systems may compute a degree of familiarity between two or more entities (for example, a degree of familiarity between two people represented as nodes in a social media graph and connected by an edge of the graph). In computing systems that compute familiarity scores, some factors that may be considered in computing a degree of familiarity are country of origin, religion, ethnicity, age, friends on the platform, membership in the same group on a platform, history of shared virtual environments (e.g., players who played together in previous games or users who attended the same webinar series), and the like.

### SUMMARY

Embodiments of the present disclosure include a system, method, and computer program product for detection and mitigation of inappropriate behavior in a virtual environment. A system in accordance with the present disclosure may include a memory and a processor in communication with the memory. The processor may be configured to perform operations. The operations may include detecting a discussion between a first user and a second user and analyzing the discussion for one or more toxicity indicators. The operations may include calculating a first user toxicity score based on the one or more toxicity indicators and implementing, automatically, a response to the first user toxicity score.

The above summary is not intended to describe each illustrated embodiment or every implementation of the disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a flowchart of a system for detecting and mitigating inappropriate behavior in accordance with some embodiments of the present disclosure.

FIG. 2 depicts a flowchart of a system for detecting and mitigating inappropriate behavior in accordance with some embodiments of the present disclosure.

FIG. 3 illustrates a method for detecting and mitigating inappropriate behavior in accordance with some embodiments of the present disclosure.

FIG. 4 depicts a method for detecting and mitigating inappropriate behavior in accordance with some embodiments of the present disclosure.

FIG. 5 illustrates a method for detecting and mitigating inappropriate behavior in accordance with some embodiments of the present disclosure.

FIG. 6 depicts a block diagram of an example computing environment in which illustrative embodiments of the present disclosure may be implemented.

FIG. 7 illustrates a block diagram of an example natural language processing system configured to analyze a recording to identify a particular subject of a query, in accordance with embodiments of the present disclosure.

FIG. 8 depicts a block diagram illustrating an embodiment of a computer system, and the components thereof, upon which embodiments described herein may be implemented in accordance with the present disclosure.

FIG. 9 illustrates a block diagram illustrating an extension of the computing system environment of FIG. 8 wherein the computer systems are configured to operate in a network environment (including a cloud environment) and perform methods described herein in accordance with the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to inappropriate content detection and more specifically to detection and mitigation of inappropriate behavior in a virtual environment.

Virtual environments may be used for collaboration in work and/or play. In some virtual environments, inappropriate behavior may exist. The present disclosure concerns how to address inappropriate content (e.g., toxic behavior) in a virtual environment, including detection and mitigation of inappropriate behavior in a virtual environment.

In some embodiments of the present disclosure, a method of detecting toxicity in a virtual environment may include detecting speech of a participant of the virtual environment, analyzing the speech, and developing a toxicity score for the participant. Analyzing the speech may include tone analysis. Analyzing the speech may produce an analysis, and the toxicity score developed for the participant may be based on the analysis. In some embodiments, analyzing the speech may include categorizing the speech in terms of magnitude of toxicity and/or frequency of toxic comments. Some embodiments may include generating a profile for the participant with the toxicity score and/or updating the profile for the participant with the toxicity score.

In some embodiments of the present disclosure, analyzing the speech may include identifying the cultural context of the participant. The cultural context of the participant may include, for example, geography, language, age, background, and/or education of the participant.

In some embodiments of the present disclosure, analyzing the speech may include identifying the relationship of the participant to other participants of the virtual environment. In some embodiments, the toxicity score may be increased if the participant is unfamiliar with one or more other participants in the virtual environment and/or decreased if the participant is familiar with one or more other participants in the virtual environment.

Some embodiments may include correlating the toxicity score with an event in the virtual environment. Some embodiments may include detecting a second event in the virtual environment after correlating the toxicity score with the event in the virtual environment, and some embodiments may further include predicting a toxic action of the participant based on the correlating the toxicity score with the event in the virtual environment and detecting the second event in the virtual environment. In some embodiments, the event may be an action performed by an avatar of the participant in the virtual environment.

Some embodiments may include presenting the toxicity score to a human moderator.

The present disclosure discusses the detection of toxicity with respect to text and speech interactions between users in a virtual environment. Such interactions may be evaluated based on the text and speech of the users as well as the actions and reactions of the users in a shared virtual environment. The present disclosure discusses considering whether a combination of one or more actions and/or comments results in behavior that is inappropriate; even though an individual action and/or comment may not rise to the level of inappropriate, the combination thereof may result in the recognition of inappropriate behavior and may thus result in a detection engine recommending and/or engaging in one or more disciplinary actions.

For example, two users may be players in a game in a virtual environment; the players may use vulgarity as they play together and may speak in even tones and act cooperatively. The system may determine that the behavior is not inappropriate. Later in the game, the players may raise their voices, the tonality of their voices may change, and they may act in a taunting manner in the virtual environment; the system may determine, based on the combination of factors, that the behavior has become inappropriate and may thus flag the situation and recommend disciplinary action against one or both of the players such as squelching the players for fifteen minutes.

The present disclosure discusses the detection of toxicity considering text, speech, and/or other interactions between users. Users may be, for example, players in a game in a virtual environment or participants in an online conference. Interactions may include text, speech, actions of one or more users, and/or reactions of one or more other users. The present disclosure discusses considering the combination of one or more events (e.g., an action following a comment, an action and a reaction, a string of comments, and/or a cluster of actions and/or reactions). A combination of events and/or contexts may, for example, elevate a toxicity score such that a detection engine may not have recommended disciplinary action for any of the events individually but may recommend disciplinary action for the events in the aggregate.

In some circumstances, a combination of events and/or contexts may decrease a toxicity score such that a detection engine may have recommended disciplinary action for an individual event but may not recommend disciplinary action for the events in the aggregate. For example, the present disclosure considers that a familiarity between users may result in the users employing language considered toxic in a non-toxic way (e.g., as part of an inside joke). A detection engine may recognize an otherwise toxic event as non-toxic, for example, based on how the other users react to the event (e.g., lighthearted laughter or an appreciative response).

The present disclosure considers various aspects for detecting events and behaviors that may be truly toxic (e.g., appear toxic on its face but is not toxic or, alternatively, may not appear toxic on its face but is toxic in effect). For example, a detection engine may implement a toxicity classification system (as in, severity levels) and/or consider familiarity (e.g., relationships between) users in a shared environment (e.g., a virtual gaming platform). A detection engine may recommend disciplinary action for a user engaging in toxicity (e.g., making toxic comments or acting in a toxic way in a shared virtual environment).

In some embodiments, a detection engine may recommend implementing prohibitions based on detected toxicity. Such recommendations may include, for example, squelching a user for a predetermined time period based on the severity of language used, removal of the user from the virtual environment, suspension of a user account, and/or banning the user from the platform. Such recommendations may be based on, for example, the specific toxic behaviors the user engages in, the context of the flagged event, whether a user has a history of toxic behaviors, a sensitivity level of the platform (e.g., a platform designed for children may have a heightened sensitivity to vulgarity compared to a platform designed for adults), the demographics of the audience of the platform, the other users in the shared virtual environment (e.g., whether the other users directly impacted would be likely to perceive the event as toxic), and similar factors.

The present disclosure considers training a detection engine with historical data (e.g., predetermined, static, and/or indexed data) to enable the detection engine to identify toxicity and/or refine the identification thereof. A detection engine may use text, speech, interactions between users (e.g., actions and reactions), and/or combinations thereof to determine whether or not certain events are toxic. If an event is flagged as toxic, the detection engine may recommend one or more disciplinary actions for the user based on the toxic event, the user profile (e.g., whether the user has a history of toxic engagement), and the context (e.g., whether the user was provoked and/or the toxicity sensitivity of the platform).

In some embodiments, the present disclosure may use machine learning (ML) and/or natural language processing (NLP) to determine whether certain events (e.g., remarks, behaviors, and/or combinations thereof) may be toxic and/or to assign a toxicity severity score to an event. A detection engine may be used for identifying a toxic event, assigning a severity score to the event, and/or recommending a response to discourage similar events.

The present disclosure discusses toxicity detection and/or response in real time. In some implementations of the present disclosure, a platform may have thousands of virtual environments each with distinct groups of different users. A detection engine may be used to detect toxicity in real time and, for example, flag toxicity to a human moderator. The detection engine may provide reasoning for the toxicity flag and/or toxicity severity score. The detection engine may provide a recommended response, one or more alternative recommendations, and/or reasons for implementing a response; the detection engine may, for example, specify that a certain response is likely to reduce toxicity in the virtual environment.

In some embodiments, a detection engine may monitor one or more virtual environments in real time to streamline the moderation process for one or more human moderators. The detection engine may, for example, analyze voice messages (e.g., for profanity, tone, volume, pacing, and/or other toxicity pattern indicators), text communications, and/or actions in the virtual environment in real time to identify, flag, and recommend a response to toxicity.

A system may include a memory and a processor in communication with the memory. The processor may be configured to perform operations. The operations may include detecting a discussion between a first user and a second user and analyzing the discussion for one or more toxicity indicators. The operations may also include calculating a first user toxicity score based on the one or more toxicity indicators and automatically implementing a response to the first user toxicity score.

In some embodiments of the present disclosure, the response to the first user toxicity score may include flagging the first user as toxic, noting the toxicity event in a profile associated with the first user, squelching (e.g., muting the user in a speech conversation and/or preventing posts and/or comments from the user in a written conversation) the first user for a predetermined period of time, removal of the user from discussion mediums (e.g., moved into a channel that prevents discussion), suspending the user from discussion mediums (e.g., removal from a chat channel for a predetermined time out period or until a moderator approves reentry), notification of an identified toxic activity to a moderator, or some combination thereof.

In some embodiments, the response may be based on the context, the specific behavior flagged as toxic, the first user toxicity score, a first user profile (e.g., whether or not the first user has a history of engaging in toxic behavior, the recency of any previous toxic behavior, a pattern of toxic behavior, and the like), a second user profile (e.g., whether or not the second user has a history of taunting other users or otherwise provoking others into toxic behaviors), a familiarity between the users (e.g., whether some or all of the users present have participated in the same virtual environment previously or entered the current virtual environment together and/or at the same time), a history of one or more users, a sensitivity of the platform (e.g., a virtual environment for students in online grade school activities may enforce stricter toxicity boundaries than one for casual gamers playing a mature-rated game), or some combination thereof.

In some embodiments, the operations may further include adjusting the first user toxicity score based on a familiarity between the first user and the second user.

In some embodiments of the present disclosure, analyzing the discussion may include at least one selected from the group consisting of evaluating a toxicity event magnitude, evaluating a toxicity event frequency, identifying a context, and identifying a relationship between the first user and the second user.

In some embodiments of the present disclosure, the operations may include notifying a human moderator of the first user toxicity score. In some embodiments, the operations may further include triggering the notifying the human moderator of the first user toxicity score based on the may be based on one or more of the first user toxicity score, a toxicity sensitivity, a toxicity event magnitude, a toxicity event frequency, a context, and/or a familiarity between the users.

In some embodiments of the present disclosure, the operations may also include updating a first user profile of the first user with the first user toxicity score.

In some embodiments of the present disclosure, the operations may also include correlating at least one of the one or more toxicity indicators with an event in a virtual environment shared by the first user and the second user. In some embodiments, the event may be an action performed by an avatar in the virtual environment; in some embodiments, the avatar may be controlled by either the first user or the second user. In some embodiments, the operations may further include detecting a second event in the virtual environment and predicting a toxic action of either the first user or the second user. In some embodiments, the prediction may be based on one or more of the group consisting of the correlation of the one or more toxicity indicators with the event in the virtual environment, the second event in the virtual environment, the first user profile, and/or the second user profile.

In some embodiments, the operations may further include predicting a toxic reaction to an event in a virtual environment shared by the first user and the second user.

In some embodiments, the discussion detected is in a virtual environment.

In some embodiments, analyzing the discussion includes at least one selected from the group consisting of tone analysis and vulgarity. In some embodiments, analyzing may include determining toxicity magnitude and toxicity frequency such as by categorizing the speech in terms of magnitude and frequency of toxic comments. In some embodiments, analyzing may include considering a context; the context may be selected from the group consisting of cultural, geographic, linguistic, other demographic, or other contextual factors. In some embodiments, analyzing may include identifying a cultural context of one or more users.

In some embodiments, analyzing may include identifying one or more relationships between a user and other participants in a virtual environment. In some embodiments, analyzing may include determining a relationship between a first user and a second user.

Some embodiments of the present disclosure may include calculating a familiarity score based on one or more relationships between users and adjusting one or more toxicity scores based on the familiarity score. In some embodiments, the toxicity score may be increased if the first user is unfamiliar with one or more other participants.

Some embodiments of the present disclosure may include generating a first user profile for the first user and/or updating the first user profile.

Some embodiments of the present disclosure may include correlating a toxicity score with an event in a virtual environment. For example, a detection engine may flag an event as toxic. In some embodiments, the event may have been a reaction to another event, and the detection engine may flag both the reaction and the preceding event (e.g., a provocation) as toxic.

In some embodiments of the present disclosure, the event may be an action performed by an avatar of the first user in the virtual environment. In some embodiments, the event may be an action performed by a participant in the virtual environment (e.g., a first user or a second user) or another user in the shared virtual environment that is not in the discussion (e.g., participating in a game but not in the linked voice chat).

Some embodiments of the present disclosure may include detecting a second event in the virtual environment. Some embodiments may include predicting a toxic action of a user. For example, a detection engine may detect a second event and predict a toxic response from a user.

Some embodiments of the present disclosure may include notifying a moderator of the first user toxicity score, for example, by presenting the toxicity score to a human moderator.

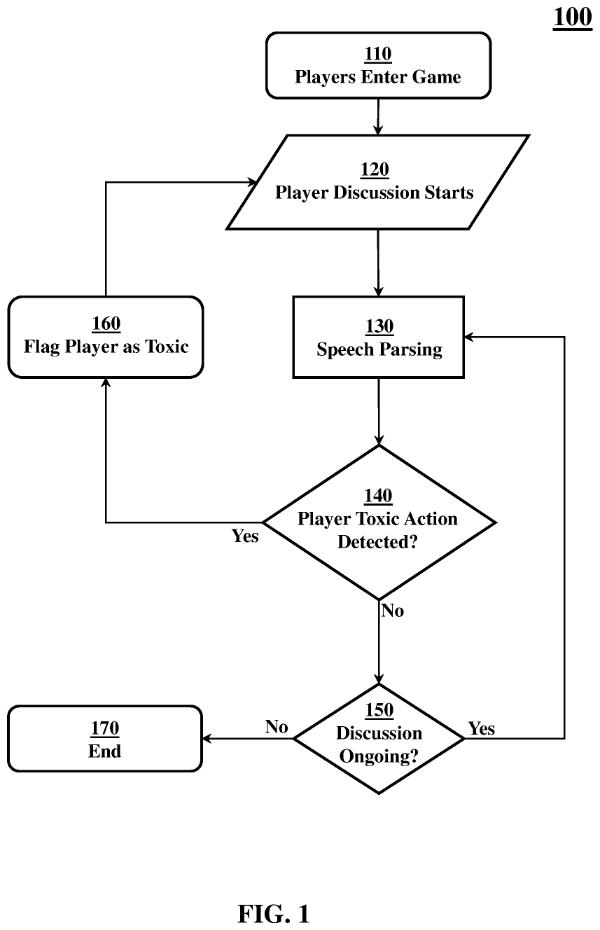

FIG. 1 illustrates a flowchart 100 of a system for detecting and mitigating inappropriate behavior in accordance with some embodiments of the present disclosure. The flowchart 100 commences with players entering 110 a game. A player discussion may start 120 and a parser may begin parsing 130 the speech of the players.

The discussion may include, for example, written, verbal, and/or nonverbal (e.g., body language, facial expressions, and/or avatar actions) communication. The parser may be a detection engine. The parser may continuously monitor the discussion to analyze the discussion for toxicity indicators. Toxicity indicators may include, for example, toxic language in the discussion (e.g., whether vulgarity and/or demeaning words are used), tone, pacing, volume, and the like.

The speech parser may monitor the discussion for signs of toxicity. The speech parser may detect 140 one or more player actions. The speech parser may determine one or more actions (e.g., written, verbal, or non-verbal messages) are not toxic and the flowchart 100 may continue with the speech parser assessing 150 whether the discussion is ongoing. The speech parser may determine that the discussion is ongoing and may continue parsing 130 the speech thereof; the speech parser may determine that the discussion is no longer ongoing and the speech parsing 130 of the discussion may thus end 170.

The speech parser may detect 140 toxicity while parsing 130 the discussion. The speech parser may identify the action as toxic and/or flag 160 the player as toxic. In some embodiments, flagging the player as toxic may automatically result in a response (e.g., the speech parser may warn the player about unacceptable behavior, squelch the player, and/or notify a human moderator of the toxicity).

In some embodiments, flagging the player as toxic may result in the player flagged as toxic being removed from the conversation (e.g., the player may have spoken using vulgarity and may be removed from the voice chat for five minutes). In some embodiments, a new discussion may start 120 and the speech parser may begin parsing 130 the speech of the participants. The speech parser may continue parsing 130 the speech in the discussion until the discussion ends.

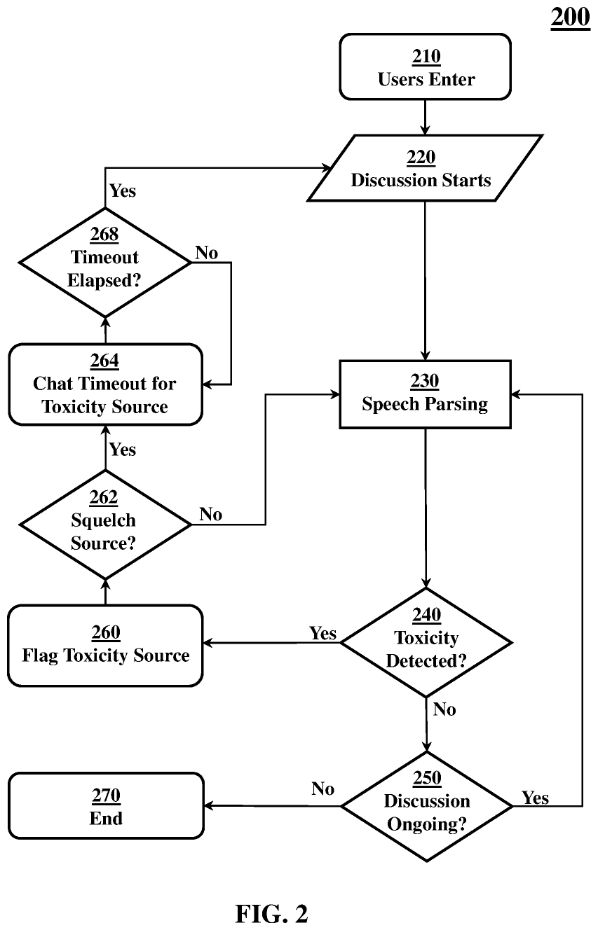

FIG. 2 depicts a flowchart 200 of a system for detecting and mitigating inappropriate behavior in accordance with some embodiments of the present disclosure. The flowchart 200 commences with users entering 210 a shared environment. A discussion may start 220 and a detection engine may parse 230 the communication of the users in the discussion. The discussion may include, for example, written, verbal, and/or nonverbal communication. The detection engine may continuously analyze the discussion for toxicity indicators. Toxicity indicators may include, for example, certain patterns in language, tone, pacing, volume, and the like.

The detection engine may monitor the discussion for signs of toxicity. The detection engine may detect 240 one or more user actions and may determine the toxicity level of the action(s). The detection engine may determine that the action(s) are not toxic; the flowchart 200 may continue with the detection engine assessing 250 whether the discussion is ongoing. The detection engine may determine that the discussion is no longer ongoing, that monitoring is no longer necessary, and may thus end 270 the process; alternatively, the detection engine may determine that the discussion is ongoing and may continue parsing 230 the speech thereof.

The detection engine may detect 240 toxicity while parsing 230 the discussion. The speech parser may identify the action as toxic and/or flag 260 the source of the toxicity (e.g., a user, account, and/or device). In some embodiments, the detection engine may be authorized to automatically respond to toxicity if, for example, the toxicity score achieves a certain threshold.

For example, in some embodiments, an operator may identify a toxicity score for a first offense at or above a 6.0 toxicity score automatically results in a five-minute squelch (e.g., the microphone of that user will be muted for five minutes). A detection engine may detect 240 a first user engaging in toxic behavior, calculate the behavior to have a 4.2 toxicity score, determine 262 that a squelch is not appropriate, not squelch the first user, and return to paring 230 the speech. The detection engine may detect 240 a second user engaging in toxic behavior, calculate the behavior to have a 7.3 toxicity score, determine 262 that a squelch is appropriate, and squelch 264 the second user for five minutes; the detection engine may continue parsing 230 the discussion between the other users while the second user is in a chat timeout until the timeout period has elapsed. The detection engine may identify 268 that the timeout has elapsed and may unsquelch the second user to enable the second user to rejoin the conversation.

A detection engine may flag 260 an action as toxic or inappropriate whether or not the behavior rises to the level of requiring a punitive response. In some embodiments, the detection engine may respond by, for example, making a note in a user profile that the user speaks with profanity that does not rise to an actionable level. In some embodiments, the detection engine may respond by warning the user against the identified toxic behavior. In some embodiments, the detection engine may respond by notifying a human moderator that a user is speaking, emoting, typing, or otherwise acting in a toxic manner; for example, the detection engine may notify a human moderator that the behavior of the user does not in any singular instance rise to a punitive level but that the user has ten moderately toxic actions and the detection engine thus recommends the human moderator to remind the user of community guidelines and/or policies.

In some embodiments, multiple thresholds and/or responses may be used to further enable the detection engine to respond to toxicity in real time. Thresholds may include and/or consider, for example, an identified toxicity score, number of offenses, frequency, magnitude, relationship or lack thereof, familiarity or lack thereof, toxicity sensitivity, related factor, or some combination thereof. A response may include, for example, a warning (e.g., a text notice direct to the user engaging in the toxic behavior and/or an audio indication that an action the user performed was unacceptable), squelch timeout (e.g., from text chat or voice chat), notation added to the user profile, notification sent to a moderator, suspension (e.g., from text chat, voice chat, a virtual environment, certain areas on the platform, and/or the entire platform), ban (e.g., from text chat, voice chat, a virtual environment, certain areas on the platform, and/or the entire platform), similar corrections or prohibitions, or some combination thereof.

A computer-implemented method in accordance with the present disclosure may include detecting a discussion between a first user and a second user and analyzing the discussion for one or more toxicity indicators. The method may also include calculating a first user toxicity score based on the one or more toxicity indicators and automatically implementing a response to the first user toxicity score.

In some embodiments, the method may further include adjusting the first user toxicity score based on a familiarity between the first user and the second user.

In some embodiments of the present disclosure, analyzing the discussion may include at least one selected from the group consisting of evaluating a toxicity event magnitude, evaluating a toxicity event frequency, identifying a context, and identifying a relationship between the first user and the second user.

In some embodiments of the present disclosure, the method may also include notifying a human moderator of the first user toxicity score. In some embodiments, the method may further include triggering the notifying the human moderator of the first user toxicity score based on the may be based on one or more of the first user toxicity score, a toxicity sensitivity, a toxicity event magnitude, a toxicity event frequency, a context, and/or a familiarity between the users.

In some embodiments of the present disclosure, the method may also include updating a first user profile of the first user with the first user toxicity score.

In some embodiments of the present disclosure, the method may also include correlating at least one of the one or more toxicity indicators with an event in a virtual environment shared by the first user and the second user. In some embodiments, the event may be an action performed by an avatar in the virtual environment; in some embodiments, the avatar may be controlled by either the first user or the second user. In some embodiments, the method may further include detecting a second event in the virtual environment and predicting a toxic action of either the first user or the second user. In some embodiments, the prediction may be based on one or more of the group consisting of the correlation of the one or more toxicity indicators with the event in the virtual environment, the second event in the virtual environment, the first user profile, and/or the second user profile.

In some embodiments, the method may further include predicting a toxic reaction to an event in a virtual environment shared by the first user and the second user.

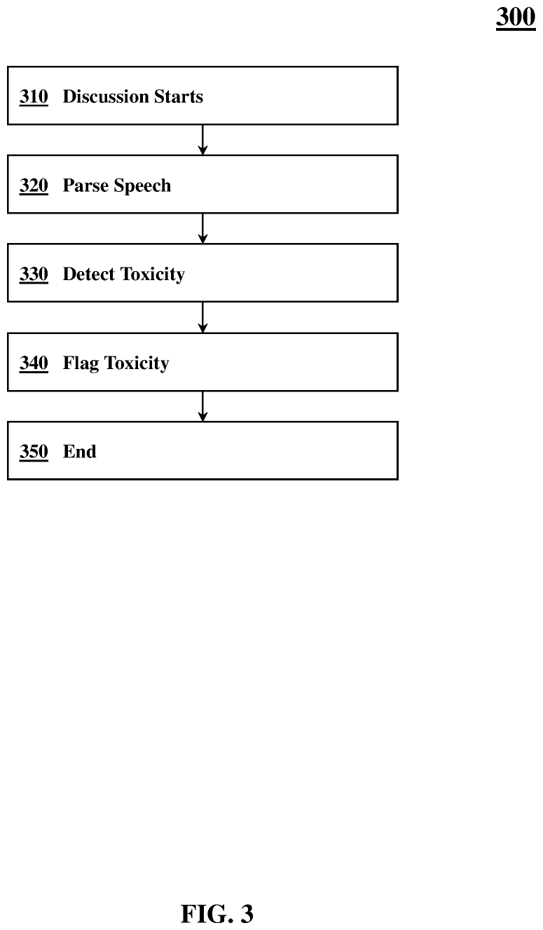

FIG. 3 illustrates a method 300 for detecting and mitigating inappropriate behavior in accordance with some embodiments of the present disclosure. The method 300 includes a discussion starting 310, parsing 320 the speech (e.g., textual, verbal, and/or non-verbal) of the discussion, and detecting 330 toxicity. The method 300 includes flagging 340 the toxicity and the method 300 ending 350. In some embodiments, a detection engine may perform one or more operations of the method 300.

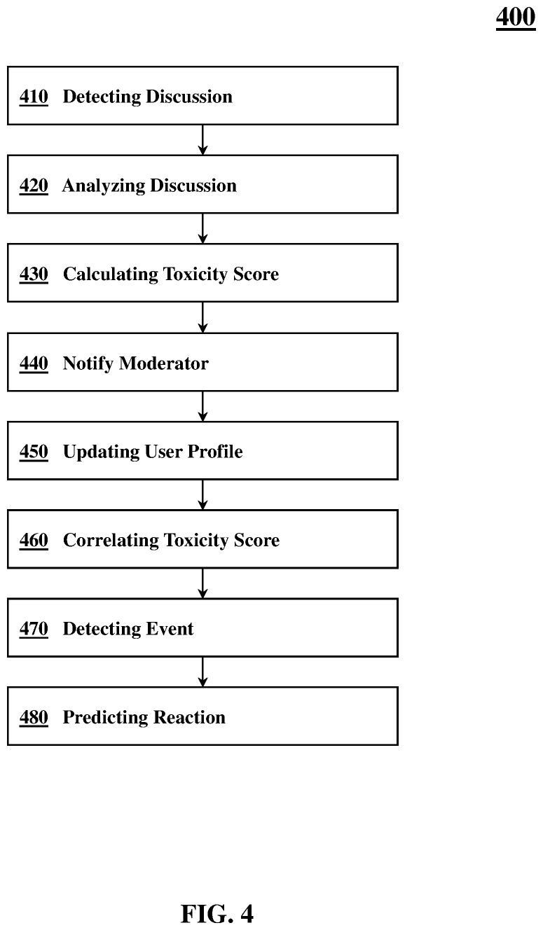

FIG. 4 depicts a method 400 for detecting and mitigating inappropriate behavior in accordance with some embodiments of the present disclosure. The method 400 includes detecting 410 a discussion, analyzing 420 the discussion, and calculating 430 a toxicity score. The method 400 includes notifying 440 a moderator, updating 450 a user profile, and correlating 460 a toxicity score. The method 400 includes detecting 470 an event and predicting 480 a reaction.

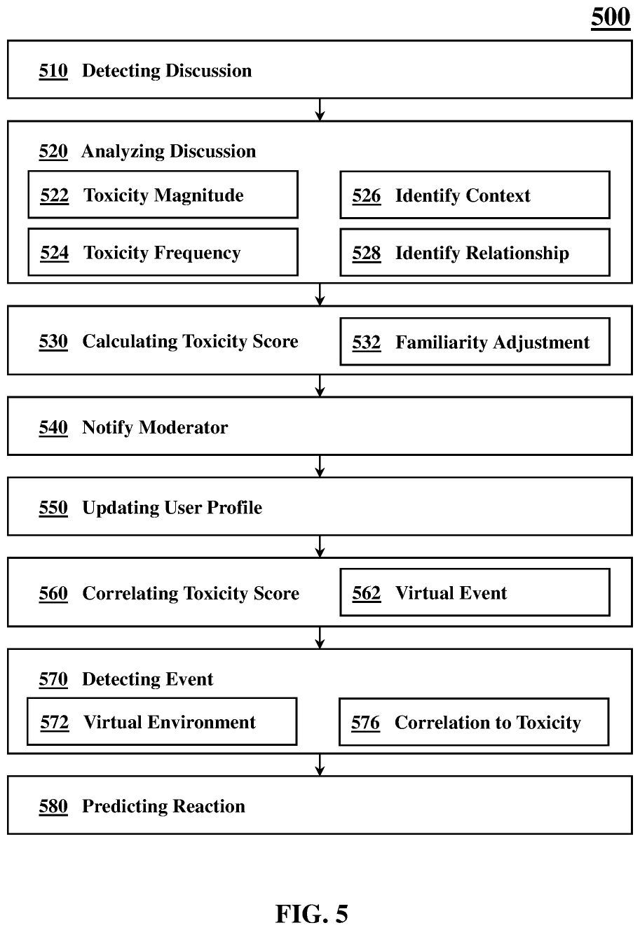

FIG. 5 illustrates a method 500 for detecting and mitigating inappropriate behavior in accordance with some embodiments of the present disclosure. The method 500 includes detecting 510 a discussion, analyzing 520 the discussion, and calculating 530 a toxicity score. The method 500 includes notifying 540 a moderator, updating 550 a user profile, and correlating 560 a toxicity score. The method 500 includes detecting 570 an event and predicting 580 a reaction.

The method 500 includes analyzing 520 the discussion. Analyzing 520 the discussion may include evaluating and/or categorizing the speech in terms of toxicity magnitude 522 and/or toxicity frequency 524. Analyzing 520 the discussion may include identifying a context 526 and/or identifying a relationship 528.

The context 526 identified may be a cultural context of one or more of the participants (e.g., users or players in the virtual environment), such as the participant performing a potentially toxic action (e.g., using certain profanity) and/or witnesses to the action (e.g., the participant the profanity seems to be directed at and/or an observer of the comment). The context 526 may be a cultural context 526 which may consider, for example, geography, age and other demographics, language, culture, and the like. The context 526 identified may be a situational context 526 which may consider, for example, the circumstances of the action, other actions in the session (e.g., the prevalence of the use of vulgarity by others in the virtual environment), other actions on the platform, familiarity between participants, and the like.

Analyzing 520 the discussion may include identifying a relationship 528. The relationship 528 may be a relationship between the actor and another participant, between some of the participants, or between all of the participants in the discussion. The relationship 528 may be determined by, for example, the proximity of the participants joining the discussion (e.g., multiple players joining a gaming lobby as a group/party or otherwise joining the lobby approximately simultaneously), the interactions between the participants (e.g., the small talk involves personal details and the fluidity of the discussion), group affiliation (e.g., tags used by host members to affiliate with a host entity or players in a gaming clan), self-identification, or the like.

The method 500 includes calculating 530 a toxicity score. Calculating 530 the toxicity score may include, for example, aggregating data from the analysis generated by analyzing 520 the discussion. Calculating 530 the toxicity may include using the toxicity magnitude 522 and the toxicity frequency 524 to determine a base toxicity score and adjusting the base toxicity score with the context 526 and/or relationship 528 information. Calculating 530 the toxicity score may, for example, include a familiarity adjustment 532 such that the toxicity score is decreased if a familiarity (e.g., a relationship between participants) is identified. In some embodiments, the familiarity adjustment 532 may be such that the toxicity score is increased if the detection engine determines that the participants are unfamiliar with each other (e.g., if the participant performing the action did not know another participant before joining the discussion). In some embodiments, the detection engine may not perform a familiarity adjustment 532, for example, because the detection engine does not have data to conclude familiarity or lack thereof.

The method 500 includes correlating 560 a toxicity score. The toxicity score may be correlated to another action or event within the discussion and/or in the virtual environment; for example, one action flagged as toxic may be correlated with a string of toxic events, and the detection engine could determine that a toxicity score for an action performed by a user only exceeds a threshold when the user shares the virtual environment with another specific user and/or when another participant uses a certain phrase. The toxicity score may be correlated with a virtual event 562 which may be a specific event in the virtual environment; for example, a user may have uttered profanity in response to an avatar in a shared virtual environment performing an action, and the detection engine may determine the profanity was a toxic event that correlated with the action of the avatar which may have also been a toxic event (e.g., a provocation).

The method 500 includes detecting 570 an event. In some embodiments, detecting 570 the event may be based at least in part on correlating 560 the toxicity score to the event; for example, the detection engine may correlate a toxic behavior with an action in the virtual environment, and the action itself may not have been identified by the detection engine but the combination of the action and the toxic response may result in the detection engine detecting 570 the action. Detecting 570 an event may include detecting 570 a second event; for example, the detection engine may determine that a first event leads or will lead to a second event.

The event detected may be an event in the virtual environment 572; for example, the detection engine may determine that a first action by a first user in the virtual environment 572 is correlated with a second action by a second user in the virtual environment 572. The event detected may have a correlation to the toxicity 576 of another action; for example, the second user may have responded to a first toxic action with a second toxic action, and the detection engine may correlate the two toxic actions.

The method 500 includes predicting 580 a reaction. The reaction predicted may be based on the event detected. For example, a detection engine may identify that a first user is likely to react to certain words and/or actions with vulgarity; the detection engine may detect a second user says one of the words that the first user is likely to respond to with vulgarity, and the detection engine may thus predict that the first user will respond to the second user with vulgarity. In some embodiments, the detection engine may identify that the second user is familiar with the likelihood of the first user to use vulgarity in response to a certain word or phrase; the detection engine may identify that the second user is using the certain word or phrase to provoke the first user into engaging in vulgarity. In some embodiments, the detection engine may respond to the second user provoking the first user such as by, for example, warning the second user that provocation of toxicity may itself be considered toxic and/or otherwise respond to the second user by treating the provocative action as toxic.

A computer program product in accordance with the present disclosure may include a computer readable storage medium having program instructions embodied therewith. The program instructions may be executable by a processor to cause the processor to perform a function. The function may include detecting a discussion between a first user and a second user and analyzing the discussion for one or more toxicity indicators. The function may also include calculating a first user toxicity score based on the one or more toxicity indicators and automatically implementing a response to the first user toxicity score.

In some embodiments, the function may further include adjusting the first user toxicity score based on a familiarity between the first user and the second user.

In some embodiments of the present disclosure, analyzing the discussion may include at least one selected from the group consisting of evaluating a toxicity event magnitude, evaluating a toxicity event frequency, identifying a context, and identifying a relationship between the first user and the second user.

In some embodiments of the present disclosure, the function may also include notifying a human moderator of the first user toxicity score. In some embodiments, the function may further include triggering the notifying the human moderator of the first user toxicity score based on the first user toxicity score exceeding a toxicity threshold. In some embodiments, toxicity threshold may be based on one or more of the first user toxicity score, a toxicity sensitivity, a toxicity event magnitude, a toxicity event frequency, a context, and/or a familiarity between the users.

In some embodiments of the present disclosure, the function may also include updating a first user profile of the first user with the first user toxicity score.

In some embodiments of the present disclosure, the function may also include correlating at least one of the one or more toxicity indicators with an event in a virtual environment shared by the first user and the second user. In some embodiments, the event may be an action performed by an avatar in the virtual environment; in some embodiments, the avatar may be controlled by either the first user or the second user. In some embodiments, the function may further include detecting a second event in the virtual environment and predicting a toxic action of either the first user or the second user. In some embodiments, the prediction may be based on one or more of the group consisting of the correlation of the one or more toxicity indicators with the event in the virtual environment, the second event in the virtual environment, the first user profile, and/or the second user profile.

In some embodiments, the function may further include predicting a toxic reaction to an event in a virtual environment shared by the first user and the second user.

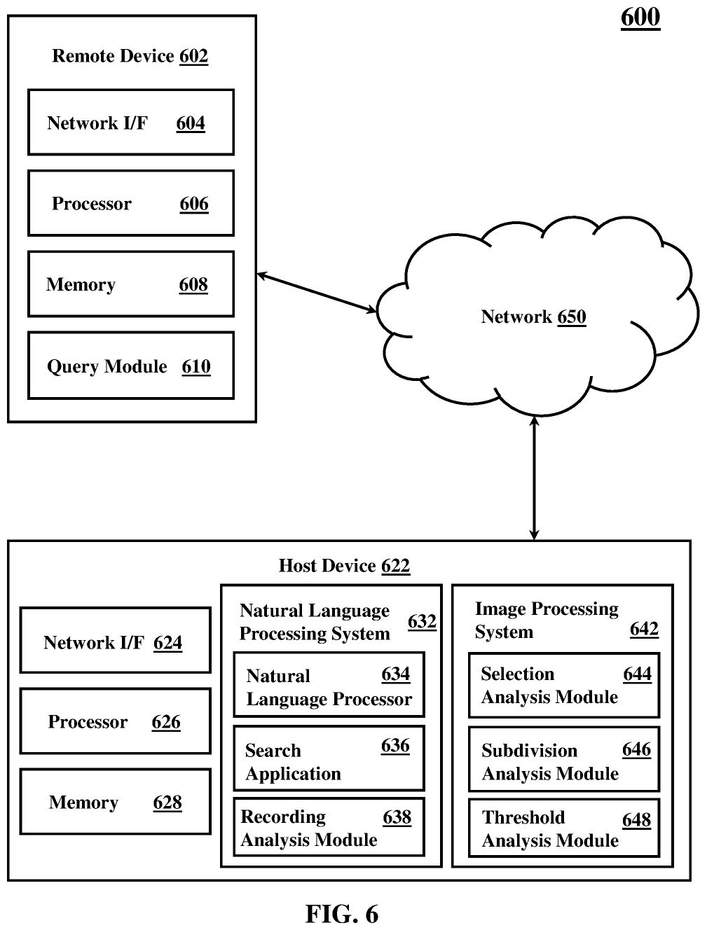

Some embodiments of the present disclosure may utilize a natural language parsing and/or subparsing component. Thus, aspects of the disclosure may relate to natural language processing. Accordingly, an understanding of the embodiments of the present invention may be aided by describing embodiments of natural language processing systems and the environments in which these systems may operate. Turning now to FIG. 6, illustrated is a block diagram of an example computing environment 600 in which illustrative embodiments of the present disclosure may be implemented. In some embodiments, the computing environment 600 may include a remote device 602 and a host device 622.

Consistent with various embodiments of the present disclosure, the host device 622 and the remote device 602 may be computer systems. The remote device 602 and the host device 622 may include one or more processors 606 and 626 and one or more memories 608 and 628, respectively. The remote device 602 and the host device 622 may be configured to communicate with each other through an internal or external network interface 604 and 624. The network interfaces 604 and 624 may be modems or network interface cards. The remote device 602 and/or the host device 622 may be equipped with a display such as a monitor. Additionally, the remote device 602 and/or the host device 622 may include optional input devices (e.g., a keyboard, mouse, scanner, or other input device) and/or any commercially available or custom software (e.g., browser software, communications software, server software, natural language processing software, search engine and/or web crawling software, filter modules for filtering content based upon predefined parameters, etc.). In some embodiments, the remote device 602 and/or the host device 622 may be servers, desktops, laptops, or hand-held devices.

The remote device 602 and the host device 622 may be distant from each other and communicate over a network 650. In some embodiments, the host device 622 may be a central hub from which remote device 602 can establish a communication connection, such as in a client-server networking model. Alternatively, the host device 622 and remote device 602 may be configured in any other suitable networking relationship (e.g., in a peer-to-peer configuration or using any other network topology).

In some embodiments, the network 650 can be implemented using any number of any suitable communications media. For example, the network 650 may be a wide area network (WAN), a local area network (LAN), an internet, or an intranet. In certain embodiments, the remote device 602 and the host device 622 may be local to each other and communicate via any appropriate local communication medium. For example, the remote device 602 and the host device 622 may communicate using a local area network (LAN), one or more hardwire connections, a wireless link or router, or an intranet. In some embodiments, the remote device 602 and the host device 622 may be communicatively coupled using a combination of one or more networks and/or one or more local connections. For example, the remote device 602 may be hardwired to the host device 622 (e.g., connected with an Ethernet cable) or the remote device 602 may communicate with the host device using the network 650 (e.g., over the Internet).

In some embodiments, the network 650 can be implemented within a cloud computing environment or using one or more cloud computing services. Consistent with various embodiments, a cloud computing environment may include a network-based, distributed data processing system that provides one or more cloud computing services. Further, a cloud computing environment may include many computers (e.g., hundreds or thousands of computers or more) disposed within one or more data centers and configured to share resources over the network 650.

In some embodiments, the remote device 602 may enable a user to input (or may input automatically with or without a user) a query (e.g., is any part of a recording artificial, etc.) to the host device 622 in order to identify subdivisions of a recording that include a particular subject. For example, the remote device 602 may include a query module 610 and a user interface (UI). The query module 610 may be in the form of a web browser or any other suitable software module, and the UI may be any type of interface (e.g., command line prompts, menu screens, graphical user interfaces). The UI may allow a user to interact with the remote device 602 to input, using the query module 610, a query to the host device 622, which may receive the query.

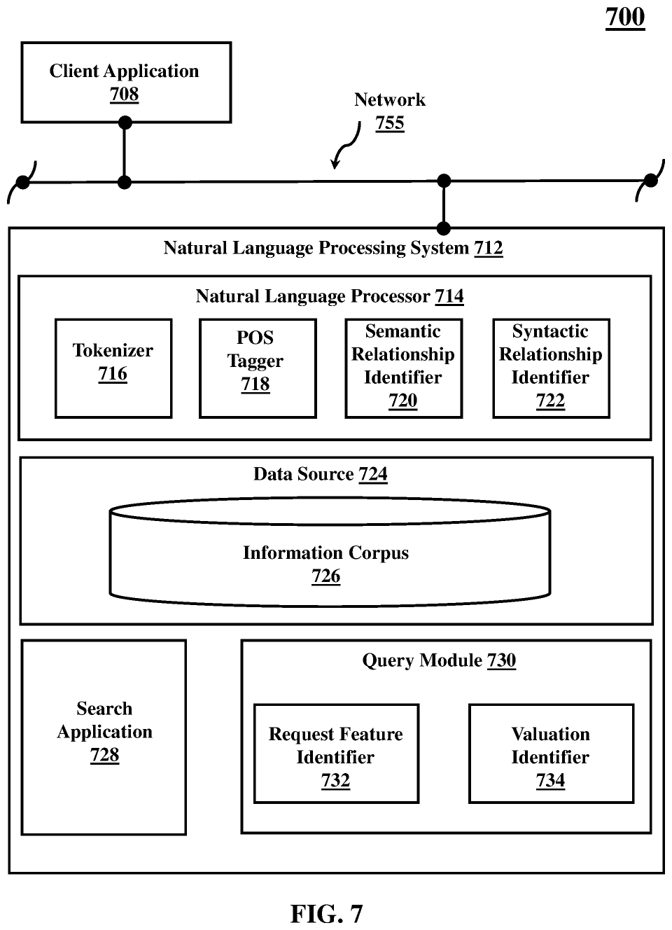

In some embodiments, the host device 622 may include a natural language processing system 632. The natural language processing system 632 may include a natural language processor 634, a search application 636, and a recording module 638. The natural language processor 634 may include numerous subcomponents, such as a tokenizer, a part-of-speech (POS) tagger, a semantic relationship identifier, and a syntactic relationship identifier. An example natural language processor is discussed in more detail in reference to FIG. 7.

The search application 636 may be implemented using a conventional or other search engine and may be distributed across multiple computer systems. The search application 636 may be configured to search one or more databases (e.g., repositories) or other computer systems for content that is related to a query submitted by the remote device 602. For example, the search application 636 may be configured to search dictionaries, papers, and/or archived reports to help identify a particular subject related to a query provided for a class. The recording analysis module 638 may be configured to analyze a recording to identify a particular subject (e.g., of the query). The recording analysis module 638 may include one or more modules or units, and may utilize the search application 636, to perform its functions (e.g., to identify a particular subject in a recording), as discussed in more detail in reference to FIG. 7.

In some embodiments, the host device 622 may include an image processing system 642. The image processing system 642 may be configured to analyze images associated with a recording to create an image analysis. The image processing system 642 may utilize one or more models, modules, or units to perform its functions (e.g., to analyze the images associated with the recording and generate an image analysis). For example, the image processing system 642 may include one or more image processing models that are configured to identify specific images related to a recording. The image processing models may include a section analysis module 644 to analyze single images associated with the recording and to identify the location of one or more features of the single images. As another example, the image processing system 642 may include a subdivision module 646 to group multiple images together identified to have a common feature of the one or more features. In some embodiments, image processing modules may be implemented as software modules. For example, the image processing system 642 may include a section analysis module and a subdivision analysis module. In some embodiments, a single software module may be configured to analyze the image(s) using image processing models.

In some embodiments, the image processing system 642 may include a threshold analysis module 648. The threshold analysis module 648 may be configured to compare the instances of a particular subject identified in a subdivision of sections of the recording against a threshold number of instances. The threshold analysis module 648 may then determine if the subdivision should be displayed to a user.

In some embodiments, the host device may have an optical character recognition (OCR) module. The OCR module may be configured to receive a recording sent from the remote device 602 and perform optical character recognition (or a related process) on the recording to convert it into machine-encoded text so that the natural language processing system 632 may perform NLP on the report. For example, a remote device 602 may transmit a video of a medical procedure to the host device 622. The OCR module may convert the video into machine-encoded text and then the converted video may be sent to the natural language processing system 632 for analysis. In some embodiments, the OCR module may be a subcomponent of the natural language processing system 632. In other embodiments, the OCR module may be a standalone module within the host device 622. In still other embodiments, the OCR module may be located on the remote device 602 and may perform OCR on the recording before the recording is sent to the host device 622.

While FIG. 6 illustrates a computing environment 600 with a single host device 622 and a remote device 602, suitable computing environments for implementing embodiments of this disclosure may include any number of remote devices and host devices. The various models, modules, systems, and components illustrated in FIG. 6 may exist, if at all, across a plurality of host devices and remote devices. For example, some embodiments may include two host devices. The two host devices may be communicatively coupled using any suitable communications connection (e.g., using a WAN, a LAN, a wired connection, an intranet, or the Internet). The first host device may include a natural language processing system configured to receive and analyze a video, and the second host device may include an image processing system configured to receive and analyze. GIFS to generate an image analysis.

It is noted that FIG. 6 is intended to depict the representative major components of an exemplary computing environment 600. In some embodiments, however, individual components may have greater or lesser complexity than as represented in FIG. 6, components other than or in addition to those shown in FIG. 6 may be present, and the number, type, and configuration of such components may vary.

Referring now to FIG. 7, shown is a block diagram of an exemplary system architecture 700 including a natural language processing system 712 configured to analyze data to identify objects of interest (e.g., possible anomalies, natural data, etc.), in accordance with embodiments of the present disclosure. In some embodiments, a remote device (such as remote device 602 of FIG. 6) may submit a text segment and/or a corpus to be analyzed to the natural language processing system 712 which may be housed on a host device (such as host device 622 of FIG. 6). Such a remote device may include a client application 708, which may itself involve one or more entities operable to generate or modify information associated with the recording and/or query that is then dispatched to a natural language processing system 712 via a network 755.

Consistent with various embodiments of the present disclosure, the natural language processing system 712 may respond to text segment and corpus submissions sent by a client application 708. Specifically, the natural language processing system 712 may analyze a received text segment and/or corpus (e.g., video, news article, etc.) to identify an object of interest. In some embodiments, the natural language processing system 712 may include a natural language processor 714, data sources 724, a search application 728, and a query module 730. The natural language processor 714 may be a computer module that analyzes the recording and the query. The natural language processor 714 may perform various methods and techniques for analyzing recordings and/or queries (e.g., syntactic analysis, semantic analysis, etc.). The natural language processor 714 may be configured to recognize and analyze any number of natural languages. In some embodiments, the natural language processor 714 may group one or more sections of a text into one or more subdivisions. Further, the natural language processor 714 may include various modules to perform analyses of text or other forms of data (e.g., recordings, etc.). These modules may include, but are not limited to, a tokenizer 716, a part-of-speech (POS) tagger 718 (e.g., which may tag each of the one or more sections of text in which the particular object of interest is identified), a semantic relationship identifier 720, and a syntactic relationship identifier 722.

In some embodiments, the tokenizer 716 may be a computer module that performs lexical analysis. The tokenizer 716 may convert a sequence of characters (e.g., images, sounds, etc.) into a sequence of tokens. A token may be a string of characters included in a recording and categorized as a meaningful symbol. Further, in some embodiments, the tokenizer 716 may identify word boundaries in a body of text and break any text within the body of text into their component text elements, such as words, multiword tokens, numbers, and punctuation marks. In some embodiments, the tokenizer 716 may receive a string of characters, identify the lexemes in the string, and categorize them into tokens.

Consistent with various embodiments, the POS tagger 718 may be a computer module that marks up a word in a recording to correspond to a particular part of speech. The POS tagger 718 may read a passage or other text in natural language and assign a part of speech to each word or other token. The POS tagger 718 may determine the part of speech to which a word (or other spoken element) corresponds based on the definition of the word and the context of the word. The context of a word may be based on its relationship with adjacent and related words in a phrase, sentence, or paragraph. In some embodiments, the context of a word may be dependent on one or more previously analyzed body of texts and/or corpora (e.g., the content of one text segment may shed light on the meaning of one or more objects of interest in another text segment). Examples of parts of speech that may be assigned to words include, but are not limited to, nouns, verbs, adjectives, adverbs, and the like. Examples of other part of speech categories that POS tagger 718 may assign include, but are not limited to, comparative or superlative adverbs, wh-adverbs, conjunctions, determiners, negative particles, possessive markers, prepositions, wh-pronouns, and the like. In some embodiments, the POS tagger 718 may tag or otherwise annotate tokens of a recording with part of speech categories. In some embodiments, the POS tagger 718 may tag tokens or words of a recording to be parsed by the natural language processing system 712.

In some embodiments, the semantic relationship identifier 720 may be a computer module that may be configured to identify semantic relationships of recognized subjects (e.g., words, phrases, images, etc.) in a body of text/corpus. In some embodiments, the semantic relationship identifier 720 may determine functional dependencies between entities and other semantic relationships.

Consistent with various embodiments, the syntactic relationship identifier 722 may be a computer module that may be configured to identify syntactic relationships in a body of text/corpus composed of tokens. The syntactic relationship identifier 722 may determine the grammatical structure of sentences such as, for example, which groups of words are associated as phrases and which word is the subject or object of a verb. The syntactic relationship identifier 722 may conform to formal grammar.

In some embodiments, the natural language processor 714 may be a computer module that may group sections of a recording into subdivisions and generate corresponding data structures for one or more subdivisions of the recording. For example, in response to receiving a text segment at the natural language processing system 712, the natural language processor 714 may output subdivisions of the text segment as data structures. In some embodiments, a subdivision may be represented in the form of a graph structure. To generate the subdivision, the natural language processor 714 may trigger computer modules 716-722.

In some embodiments, the output of natural language processor 714 may be used by search application 728 to perform a search of a set of (i.e., one or more) corpora to retrieve one or more subdivisions including a particular subject associated with a query (e.g., in regard to an object of interest) and send the output to an image processing system and to a comparator. As used herein, a corpus may refer to one or more data sources, such as a data source 724 of FIG. 7. In some embodiments, data sources 724 may include video libraries, data warehouses, information corpora, data models, and/or document repositories. In some embodiments, the data sources 724 may include an information corpus 726. The information corpus 726 may enable data storage and retrieval. In some embodiments, the information corpus 726 may be a subject repository that houses a standardized, consistent, clean, and integrated list of images and text. For example, an information corpus 726 may include teaching presentations that include step by step images and comments on how to perform a function. Data may be sourced from various operational systems. Data stored in an information corpus 726 may be structured in a way to specifically address reporting and analytic requirements. In some embodiments, an information corpus 726 may be a relational database.

In some embodiments, a query module 730 may be a computer module that identifies objects of interest within sections of a text, or other forms of data. In some embodiments, a query module 730 may include a request feature identifier 732 and a valuation identifier 734. When a query is received by the natural language processing system 712, the query module 730 may be configured to analyze text using natural language processing to identify an object of interest. The query module 730 may first identity one or more objects of interest in the text using the natural language processor 714 and related subcomponents 716-722. After identifying the one or more objects of interest, the request feature identifier 732 may identify one or more common objects of interest (e.g., anomalies, artificial content, natural data, etc.) present in sections of the text (e.g., the one or more text segments of the text). In some embodiments, the common objects of interest in the sections may be the same object of interest that is identified. Once a common object of interest is identified, the request feature identifier 732 may be configured to transmit the text segments that include the common object of interest to an image processing system (shown in FIG. 6) and/or to a comparator.

After identifying common objects of interest using the request feature identifier 732, the query module may group sections of text having common objects of interest. The valuation identifier 734 may then provide a value to each text segment indicating how close the object of interest in each text segment is related to one another (and thus indicates artificial and/or real data). In some embodiments, the particular subject may have one or more of the common objects of interest identified in the one or more sections of text. After identifying a particular object of interest relating to the query (e.g., identifying that one or more of the common objects of interest may be an anomaly), the valuation identifier 734 may be configured to transmit the criterion to an image processing system (shown in FIG. 6) and/or to a comparator (which may then determine the validity of the common and/or particular objects of interest).

It is noted that various aspects of the present disclosure may be described by narrative text, flowcharts, block diagrams of computer systems, and/or block diagrams of the machine logic included in computer program product (CPP) embodiments. With respect to any flowcharts (depending upon the technology involved), the operations can be performed in a different order than what is shown in the flowchart. For example, two operations shown in successive flowchart blocks may be performed in reverse order, as a single integrated step, concurrently, or in a manner at least partially overlapping in time. A computer program product embodiment (“CPP embodiment”) is a term used in the present disclosure that may describe any set of one or more storage media (or “mediums”) collectively included in a set of one or more storage devices.

The storage media may collectively include machine readable code corresponding to instructions and/or data for performing computer operations. A “storage device” may refer to any tangible hardware or device that can retain and store instructions for use by a computer processor. Without limitation, the computer readable storage medium may include an electronic storage medium, a magnetic storage medium, an optical storage medium, an electromagnetic storage medium, a semiconductor storage medium, a mechanical storage medium, and/or any combination thereof. Some known types of storage devices that include mediums referenced herein may include a diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc), or any suitable combination thereof. A computer-readable storage medium should not be construed as storage in the form of transitory signals per se such as radio waves, other freely propagating electromagnetic waves, electromagnetic waves propagating through a waveguide, light pulses passing through a fiber optic cable, electrical signals communicated through a wire, and/or other transmission media. As understood by those skilled in the art, data is typically moved at some occasional points in time during normal operations of a storage device, such as during access, de-fragmentation, or garbage collection, but this does not render the storage device transitory because the data is not transitory while it is stored.

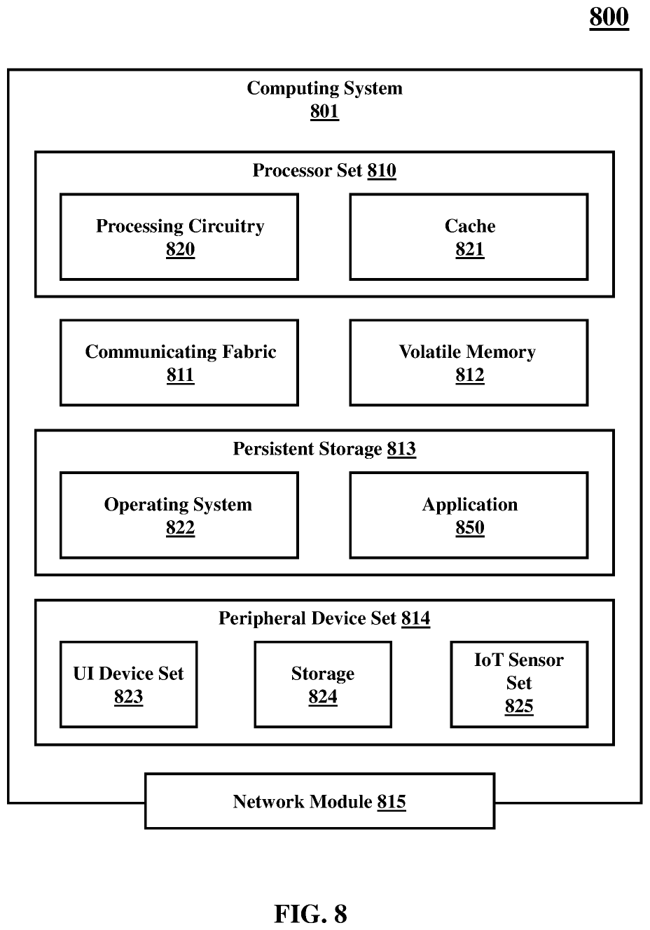

Referring now to FIG. 8, illustrated is a block diagram describing an embodiment of a computing system 801 within in a computing environment 800. The computing environment 800 may be a simplified example of a computing device (e.g., a physical bare metal system and/or a virtual system) capable of performing the computing operations described herein. Computing system 801 may be representative of the one or more computing systems or devices implemented in accordance with the embodiments of the present disclosure and further described below in detail. It should be appreciated that FIG. 8 provides only an illustration of one implementation of a computing system 801 and does not imply any limitations regarding the environments in which different embodiments may be implemented. In general, the components illustrated in FIG. 8 may be representative of an electronic device, either physical or virtualized, capable of executing machine-readable program instructions.

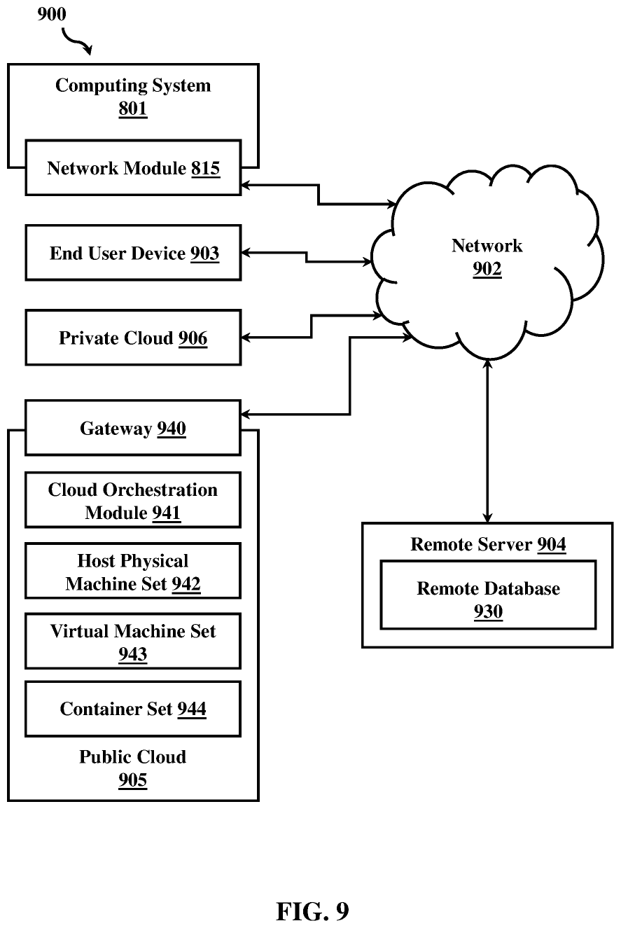

Embodiments of computing system 801 may take the form of a desktop computer, laptop computer, tablet computer, smart phone, smart watch or other wearable computer, mainframe computer, server, quantum computer, a non-conventional computer system such as an autonomous vehicle or home appliance, or any other form of computer or mobile device now known or to be developed in the future that is capable of running an application 850, accessing a network (e.g., network 902 of FIG. 9), or querying a database (e.g., remote database 930 of FIG. 9). Performance of a computer-implemented method executed by a computing system 801 may be distributed among multiple computers and/or between multiple locations. Computing system 801 may be located as part of a cloud network, even though it is not shown within a cloud in FIG. 8 or FIG. 9. Moreover, computing system 801 is not required to be in a cloud network except to any extent as may be affirmatively indicated.

The processor set 810 includes one or more computer processors of any type now known or to be developed in the future. Processing circuitry 820 may be distributed over multiple packages such as, for example, multiple coordinated integrated circuit chips. Processing circuitry 820 may implement multiple processor threads and/or multiple processor cores. The cache 821 may refer to memory that is located on the processor chip package(s) and/or may be used for data and/or code that can be made available for rapid access by the threads or cores running on the processor set 810. Cache 821 memories can be organized into multiple levels depending upon relative proximity to the processing circuitry 820. Alternatively, some or all of the cache 821 may be located “off chip.” In some computing environments, the processor set 810 may be designed for working with qubits and performing quantum computing.

Computer readable program instructions can be loaded onto the computing system 801 to cause a series of operational steps to be performed by the processor set 810 of the computing system 801 and thereby implement a computer-implemented method. Execution of the instructions can instantiate the methods specified in flowcharts and/or narrative descriptions of computer-implemented methods included in this specification (collectively referred to as “the inventive methods”). The computer readable program instructions can be stored in various types of computer readable storage media, such as cache 821 and the other storage media discussed herein. The program instructions, and associated data, can be accessed by the processor set 810 to control and direct performance of the inventive methods. In the computing environments of FIG. 8 and FIG. 9, at least some of the instructions for performing the inventive methods may be stored in persistent storage 813, volatile memory 812, and/or cache 821 as application(s) 850 comprising one or more running processes, services, programs, and installed components thereof. For example, program instructions, processes, services and installed components thereof may include the components and/or sub-components of the system 100 as shown in FIG. 1 and/or the components and/or sub-components of the system 200 as shown in FIG. 2.

The communication fabric 811 may refer to signal conduction paths that may allow the various components of the computing system 801 to communicate with each other. For example, communications fabric 811 may provide for electronic communication among the processor set 810, volatile memory 812, persistent storage 813, peripheral device set 814, and/or network module 815. The communication fabric 811 may be made of switches and/or electrically conductive paths, such as the switches and electrically conductive paths that make up busses, bridges, physical input/output ports, and the like. Other types of signal communication paths may be used such as fiber optic communication paths and/or wireless communication paths.

The volatile memory 812 may refer to any type of volatile memory now known or to be developed in the future. The volatile memory 812 may be characterized by random access; random access is not required unless affirmatively indicated. Examples include dynamic-type random access memory (RAM) or static-type RAM. In the computing system 801, the volatile memory 812 is located in a single package and can be internal to computing system 801; in some embodiments, either alternatively or additionally, the volatile memory 812 may be distributed over multiple packages and/or located externally with respect to the computing system 801. The application 850, along with any program(s), processes, services, and installed components thereof, described herein, may be stored in volatile memory 812 and/or persistent storage 813 for execution and/or access by one or more of the respective processor sets 810 of the computing system 801.

Persistent storage 813 may be any form of non-volatile storage for computers that may be currently known or developed in the future. The non-volatility of this storage means that the stored data may be maintained regardless of whether power is being supplied to the computing system 801 and/or directly to persistent storage 813. Persistent storage 813 may be a read-only memory (ROM); at least a portion of the persistent storage 813 may allow writing of data, deletion of data, and/or re-writing of data. Some forms of persistent storage 813 may include magnetic disks, solid-state storage devices, hard drives, flash-based memory, erasable read-only memories (EPROM), and semi-conductor storage devices. An operating system 822 may take several forms, such as various known proprietary operating systems or open-source portable operating system interface-type operating systems that employ a kernel.

The peripheral device set 814 may include one or more peripheral devices connected to computing system 801, for example, via an input/output (I/O) interface. Data communication connections between the peripheral devices and the other components of computing system 801 may be implemented using various methods. For example, data communication connections may be made using short-range wireless technology (e.g., a Bluetooth® connection), Near-Field Communication (NFC), wired connections or cables (e.g., universal serial bus (USB) cables), insertion-type connections (e.g., a secure digital (SD) card), connections made though local area communication networks, and/or wide area networks (e.g., the internet).

In various embodiments, the UI device set 823 may include components such as a display screen, speaker, microphone, wearable devices (e.g., goggles, headsets, and smart watches), keyboard, mouse, printer, touchpad, game controllers, and/or haptic feedback devices.

The storage 824 may include external storage (e.g., an external hard drive) or insertable storage (e.g., an SD card). The storage 824 may be persistent and/or volatile. In some embodiments, the storage 824 may take the form of a quantum computing storage device for storing data in the form of qubits.

In some embodiments, networks of computing systems 801 may utilize clustered computing and components acting as a single pool of seamless resources when accessed through a network by one or more computing systems 801. For example, networks of computing systems 801 may utilize a storage area network (SAN) that is shared by multiple, geographically distributed computer systems 801 or network-attached storage (NAS) applications.

An IoT sensor set 825 may be made up of sensors that can be used in Internet-of-Things applications. A sensor may be a temperature sensor, motion sensor, infrared sensor, or any other type of known sensor type. One or more sensors may be communicably connected and/or used as the IoT sensor set 825 in whole or in part.

The network module 815 may include a collection of computer software, hardware, and/or firmware that allows the computing system 801 to communicate with other computer systems through a network 802 such as a LAN or WAN. The network module 815 may include hardware (e.g., modems or wireless signal transceivers), software (e.g., for packetizing and/or de-packetizing data for communication network transmission), and/or web browser software (e.g., for communicating data over the network).

In some embodiments, network control functions and network forwarding functions of the network module 815 may be performed on the same physical hardware device. In some embodiments, the control functions and the forwarding functions of network module 815 may be performed on physically separate devices such that the control functions manage several different network hardware devices; for example, embodiments that utilize software-defined networking (SDN) may perform control functions and forwarding functions of the network module 815 on physically separate devices. Computer readable program instructions for performing the inventive methods may be downloaded to the computing system 801 from an external computer or external storage device through a network adapter card and/or network interface included in the network module 815.

Continuing, FIG. 9 depicts a computing environment 900 operating as part of a network. The computing environment 900 of FIG. 9 may be an extension of the computing environment 800 of FIG. 8. In addition to computing system 801, computing environment 900 may include a network 902 (e.g., a WAN or other type of computer network) connecting the computing system 801 to an end user device (EUD) 903, remote server 904, public cloud 905, and/or private cloud 906.

In this embodiment, computing system 801 includes processor set 810 (including the processing circuitry 820 and the cache 821), the communication fabric 811, the volatile memory 812, the persistent storage 813 (including the operating system 822 and the program(s) 850, as identified above), the peripheral device set 814 (including the user interface (UI), the device set 823, the storage 824, and the Internet of Things (IoT) sensor set 825), and the network module 815 of FIG. 8.

In this embodiment, the remote server 904 includes the remote database 930. In this embodiment, the public cloud 905 includes gateway 940, cloud orchestration module 941, host physical machine set 942, virtual machine set 943, and/or container set 944.

The network 902 may be comprised of wired and/or wireless connections. For example, connections may be comprised of computer hardware such as copper transmission cables, optical transmission fibers, wireless transmission, routers, firewalls, switches, gateway computers, and/or edge servers. The network 902 may be described as a WAN (e.g., the internet) capable of communicating computer data over non-local distances by any technology for communicating computer data; the network 902 may make use of technology now known or to be developed in the future. In some embodiments, the WAN may be replaced and/or supplemented by LANs designed to communicate data between devices located in a local area (e.g., a wireless network). Other types of networks that can be used to interconnect the one or more computer systems 801, EUDs 903, remote servers 904, private cloud 906, and/or public cloud 905 may include a Wireless Local Area Network (WLAN), home area network (HAN), backbone network (BBN), peer to peer network (P2P), campus network, enterprise network, the Internet, single- or multi-tenant cloud computing networks, the Public Switched Telephone Network (PSTN), and any other network or network topology known by a person skilled in the art to interconnect computing systems 801.

The EUD 903 may include any computer device that can be used and/or controlled by an end user; for example, a customer of an enterprise that operates computing system 801. The EUD 903 may take any of the forms discussed above in connection with computing system 801. The EUD 903 may receive helpful and/or useful data from the operations of the computing system 801. For example, in a hypothetical case where the computing system 801 provides a recommendation to an end user, the recommendation may be communicated from the network module 815 of the computing system 801 through a WAN network 902 to the EUD 903; in this example, the EUD 903 may display (or otherwise present) the recommendation to an end user. In some embodiments, the EUD 903 may be a client device, (e.g., a thin client), thick client, mobile computing device (e.g., a smart phone), mainframe computer, desktop computer, and/or the like.

A remote server 904 may be any computing system that serves at least some data and/or functionality to the computing system 801. The remote server 904 may be controlled and used by the same entity that operates computing system 801. The remote server 904 represents the one or more machines that collect and store helpful and/or useful data for use by other computers (e.g., computing system 801). For example, in a hypothetical case where the computing system 801 is designed and programmed to provide a recommendation based on historical data, the historical data may be provided to the computing system 801 via a remote database 930 of a remote server 904.

Public cloud 905 may be any computing systems available for use by multiple entities that provide on-demand availability of computer system resources and/or other computer capabilities including data storage (e.g., cloud storage) and computing power without direct active management by the user. The direct and active management of the computing resources of the public cloud 905 may be performed by the computer hardware and/or software of a cloud orchestration module 941. The public cloud 905 may communicate through the network 902 via a gateway 940; the gateway 940 may be a collection of computer software, hardware, and/or firmware that allows the public cloud 905 to communicate through the network 902.

The computing resources provided by the public cloud 905 may be implemented by a virtual computing environment (VCE) or multiple VCEs that may run on one or more computers making up a host physical machine set 942 and/or the universe of physical computers in and/or available to public cloud 805. A VCE may take the form of a virtual machine (VM) from the virtual machine set 943 and/or containers from the container set 944.

VCEs may be stored as images. One or more VCEs may be stored as one or more images and/or may be transferred among and/or between one or more various physical machine hosts either as images and/or after instantiation of the VCE. A new active instance of the VCE may be instantiated from the image. Two types of VCEs may include VMs and containers. A container is a VCE that uses operating system-level virtualization in which the kernel may allow the existence of multiple isolated user-space instances called containers. These isolated user-space instances may behave as physical computers from the point of view of the programs 850 running in them. An application 850 running on an operating system 822 may utilize all resources of that computer such as connected devices, files, folders, network shares, CPU power, and quantifiable hardware capabilities. The applications 850 running inside a container of the container set 844 may only use the contents of the container and devices assigned to the container; this feature may be referred to as containerization. The cloud orchestration module 941 may manage the transfer and storage of images, deploy new instantiations of one or more VCEs, and manage active instantiations of VCE deployments.

Private cloud 906 may be similar to public cloud 905 except that the computing resources may only be available for use by a single enterprise. While the private cloud 906 is depicted as being in communication with the network 902 (e.g., the Internet), in other embodiments, a private cloud 806 may be disconnected from the internet entirely and only accessible through a local/private network.

In some embodiments, a hybrid cloud may be used; a hybrid cloud may refer to a composition of multiple clouds of different types (e.g., private, community, and/or public cloud types). In a hybrid cloud system, the plurality of clouds may be implemented or operated by different vendors. Each of the multiple clouds remains a separate and discrete entity; the larger hybrid cloud architecture is bound together by standardized or proprietary technology that enables orchestration, management, and/or data/application portability between the multiple constituent clouds. In this embodiment, the public cloud 905 and the private cloud 906 may be both part of a larger hybrid cloud environment.

Although the present disclosure has been described in terms of specific embodiments, it is anticipated that alterations and modifications thereof will become apparent to the skilled in the art. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application, or the technical improvement over technologies found in the marketplace or to enable others of ordinary skill in the art to understand the embodiments disclosed herein. Therefore, it is intended that the following claims be interpreted as covering all such alterations and modifications as fall within the true spirit and scope of the disclosure.

What is claimed is:

1. A system, said system comprising:
a memory; and
a processor in communication with said memory, said processor being configured to perform operations, said operations comprising:
detecting a discussion between a first user and a second user;
analyzing said discussion for one or more toxicity indicators;
calculating a first user toxicity score based on said one or more toxicity indicators; and
implementing, automatically, a response to said first user toxicity score.

2. The system of claim 1, said operations further comprising:
adjusting said first user toxicity score based on a familiarity between said first user and said second user.

3. The system of claim 1, said operations further comprising:
notifying a human moderator of said first user toxicity score.

4. The system of claim 1, said operations further comprising:
updating a first user profile of said first user with said first user toxicity score.

5. The system of claim 1, said operations further comprising:
correlating at least one of said one or more toxicity indicators with an event in a virtual environment shared by said first user and said second user.

6. The system of claim 1, said operations further comprising:
predicting a toxic reaction to an event in a virtual environment shared by said first user and said second user.

7. A computer-implemented method, said method comprising:
detecting a discussion between a first user and a second user;
analyzing said discussion for one or more toxicity indicators;
calculating a first user toxicity score based on said one or more toxicity indicators; and
implementing, automatically, a response to said first user toxicity score.

8. The method of claim 7, further comprising:
adjusting said first user toxicity score based on a familiarity between said first user and said second user.

9. The method of claim 7, wherein analyzing said discussion includes at least one selected from the group consisting of:
evaluating a toxicity event magnitude;
evaluating a toxicity event frequency;
identifying a context; and
identifying a relationship between said first user and said second user.

10. The method of claim 7, further comprising:
notifying a human moderator of said first user toxicity score.

11. The method of claim 10, further comprising:
triggering said notifying said human moderator of said first user toxicity score based on said first user toxicity score exceeding a toxicity threshold.

12. The method of claim 7, further comprising:
updating a first user profile of said first user with said first user toxicity score.

13. The method of claim 7, further comprising:
correlating at least one of said one or more toxicity indicators with an event in a virtual environment shared by said first user and said second user.

14. The method of claim 7, further comprising:
predicting a toxic reaction to an event in a virtual environment shared by said first user and said second user.

15. A computer program product, said computer program product comprising a computer readable storage medium having program instructions embodied therewith, said program instructions executable by a processor to cause said processor to perform a function, said function comprising:
detecting a discussion between a first user and a second user;
analyzing said discussion for one or more toxicity indicators;
calculating a first user toxicity score based on said one or more toxicity indicators; and
implementing, automatically, a response to said first user toxicity score.

16. The computer program product of claim 15, said function further comprising:
adjusting said first user toxicity score based on a familiarity between said first user and said second user.

17. The computer program product of claim 15, said function further comprising:
notifying a human moderator of said first user toxicity score.

18. The computer program product of claim 15, said function further comprising:
updating a first user profile of said first user with said first user toxicity score.

19. The computer program product of claim 15, said function further comprising:
correlating at least one of said one or more toxicity indicators with an event in a virtual environment shared by said first user and said second user.

20. The computer program product of claim 15, said function further comprising:
predicting a toxic reaction to an event in a virtual environment shared by said first user and said second user.
